(19) United States
(12) Patent Application Publication
(10) Pub. No.: US 2010/0197291 A1
(43) Pub. Date: Aug. 5, 2010

(54) MOBILE TERMINAL AND PRESENCE INFORMATION MANAGEMENT METHOD THEREOF

(75) Inventors: Raymond CHO, Gyeonggi-Do (KR); Hyun-Ho Shin, Gyeonggi-Do (KR); Yong-Suk Lim, Gyeonggi-Do (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC.

(21) Appl. No.: 12/689,974

(22) Filed: Jan. 19, 2010

(30) Foreign Application Priority Data
Feb. 5, 2009 (KR) 10-2009-0009476

(51) Int. Cl. H04M 3/00

(52) U.S. Cl. 455/418

(57) ABSTRACT

Disclosed are a mobile terminal and a presence information management method thereof, wherein a reception range of presence information preset by a user is pre-stored and then presence information is received from a server according to the pre-stored reception range of the presence information upon an initiation of a presence service to thusly display on a screen, whereby upon receiving the presence service, part of presence information can be received according to the preset reception range of the presence information, or presence information relating to contacts who are not in interest or infrequently engaged in a call is not needed to be processed, resulting in reducing a current consumption due to processing of the presence information and improving a UI performance.

### CROSS-REFERENCE TO RELATED APPLICATION

Pursuant to 35 U.S.C. §119(a), this application claims the benefit of earlier filing date and right of priority to Korean Application No. 10-2009-0009476, filed on Feb. 5, 2009, the contents of which is incorporated by reference herein in its entirety.

### BACKGROUND OF THE INVENTION

1. Field of the Invention

The present invention relates to a mobile terminal capable of selectively receiving only presence information within a preset range, and a presence information management method thereof.

2. Background of the Invention

Mobile terminals may be configured to perform various functions, for example, data and voice communication, capturing images or video, storing voice, reproducing music files via a speaker system, displaying images or video and the like. Some of mobile terminals may include an additional function of playing games, and other mobile terminals may be implemented as multimedia players. In addition, in recent time, mobile terminals can receive broadcast or multicast signals to allow viewing of video or television programs.

Furthermore, many efforts are undergoing to support or enhance various functions of such mobile terminals. Such many efforts include not only changes and improvement of structural components implementing a mobile terminal but also software or hardware improvement.

The mobile terminal may execute a presence service with a server under a mobile environment. The presence service is a service for receiving and storing presence information which indicates communication availability and then sending the corresponding presence information when a user having registered as a buddy requests for the same. For the presence service, several communication mechanisms, such as an instant messaging/packet service (IM)/PS, VoIP, mobile phone, e-mail and the like, may be utilized.

An operation, by which a controller of the mobile terminal requests presence information from a presence server for reception and displays the received presence information on a screen is referred to as ‘Subscribe.’ The ‘Subscribe’ is executed for designated presence contacts (or subjects, targets) for every preset duration of time. That is, at the subscription time (or duration), the controller automatically executes subscription for the same presence contacts so as to update presence information. Here, all the presence contacts may indicate a receivable range of the presence information.

In general, for a mobile communications terminal using a wireless (radio) network, a packet service bandwidth thereof is lower and the required cost thereof is higher as compared to a wired network. Thus, in addition to the perspective of the expense, presence information and presence contacts are necessary to be optimized so as for users to identify such presence information more conveniently.

However, in the related art, only the subscription for the same presence contacts can be updated, and additionally any method for selecting presence contacts to which the users wishes to automatically subscribe has not been proposed yet.

### SUMMARY OF THE INVENTION

Therefore, an object of the present invention is to provide a mobile terminal capable of setting a reception range of presence information so as to improving efficiency of a presence information processing and reducing costs, and a presence information management method thereof.

To achieve these and other advantages and in accordance with the purpose of the present invention, as embodied and broadly described herein, there is provided a presence information management method for a mobile terminal, the method including setting a reception range of presence information, storing the set reception range of the presence information, and receiving presence information from a server according to the reception range of the presence information upon an initiation of a presence service to thereafter display the same on a screen.

The reception range of the presence information may be set, for each group, a frequency of communication, priority, an on/off line and a position. Also, the reception range of the presence information may include, for each group, the number of users for which presence information are to be displayed, a time section (range) for which presence information is to be requested from a server.

The method may further include receiving presence information relating to only a user currently engaged in a call at subscription duration for updating.

The presence information displayed on the screen or updated may be displayed by discriminating a group engaged in a call from groups not engaged in a call, and for the group engaged in a call, users who are infrequently engaged in a call are distinguishably displayed from other users.

In accordance with one embodiment of the present invention, there is provided a mobile terminal including a memory configured to store a reception range of presence information set by a user, a display unit configured to display presence information received from a server, and a controller configured to receive only presence information belonging to the reception range of presence information stored in the memory upon an initiation of a presence service and display the same on a screen of the display unit.

The reception range of the presence information may be set, for each group, a frequency of communication, priority, an on/off line and a position. Also, the reception range of the presence information may include, for each group, the number of users for which presence information are to be displayed, a time section (range) for which presence information is to be requested from a server.

The controller may be configured to receive presence information relating to only a user currently engaged in a call at subscription duration for updating.

The controller may be configured to display the presence information displayed on the screen or updated such that a group engaged in a call is discriminated from groups not engaged in a call, and for the group engaged in a call, users who are infrequently engaged in a call are distinguishably displayed from other users.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating a mobile terminal in accordance with one embodiment of the present invention;

FIG. 2 is a front perspective view of the mobile terminal in accordance with the one embodiment of the present invention;

FIG. 3 is a rear perspective view of the mobile terminal in accordance with the one embodiment of the present invention;

FIG. 4 is a block diagram of a wireless communication system operable with the mobile terminal in accordance with the one embodiment of the present invention;

FIG. 5 is an exemplary view for setting a reception range of presence information in accordance with one embodiment of the present invention;

FIG. 6 is another exemplary view for setting the reception range of presence information in accordance with one embodiment of the present invention;

FIG. 7 is an exemplary view typically showing a recent call list;

FIG. 8 is a screen displayed in case where a reception range of presence information has been set in accordance with an embodiment of the present invention; and

FIG. 9 is a flowchart illustrating a presence information management method for a mobile terminal in accordance with an embodiment of the present invention.

### DETAILED DESCRIPTION OF THE INVENTION

Description will now be given in detail of preferred configurations of mobile terminals according to the present invention, with reference to the accompanying drawings. Hereinafter, suffixes “module” and “unit or portion” for components used herein in description are merely provided only for facilitation of preparing this specification, and thus they are not granted a specific meaning or function. Hence, it should be noticed that “module” and “unit or portion” can be used together.

A mobile terminal may be implemented using a variety of different types of terminals. Examples of such terminals include mobile terminals, such as mobile phones, smart phones, notebook computers, digital broadcast terminals, Personal Digital Assistants (PDA), Portable Multimedia Players (PMP), navigators and the like, and stationary terminals, such as digital TVs, desktop computers and the like. The following description assumes that the terminal is a mobile terminal. However, it can be easily understood by those skilled in the art that the configuration according to the following description can be applied to the stationary terminals except for components particularly provided for mobility.

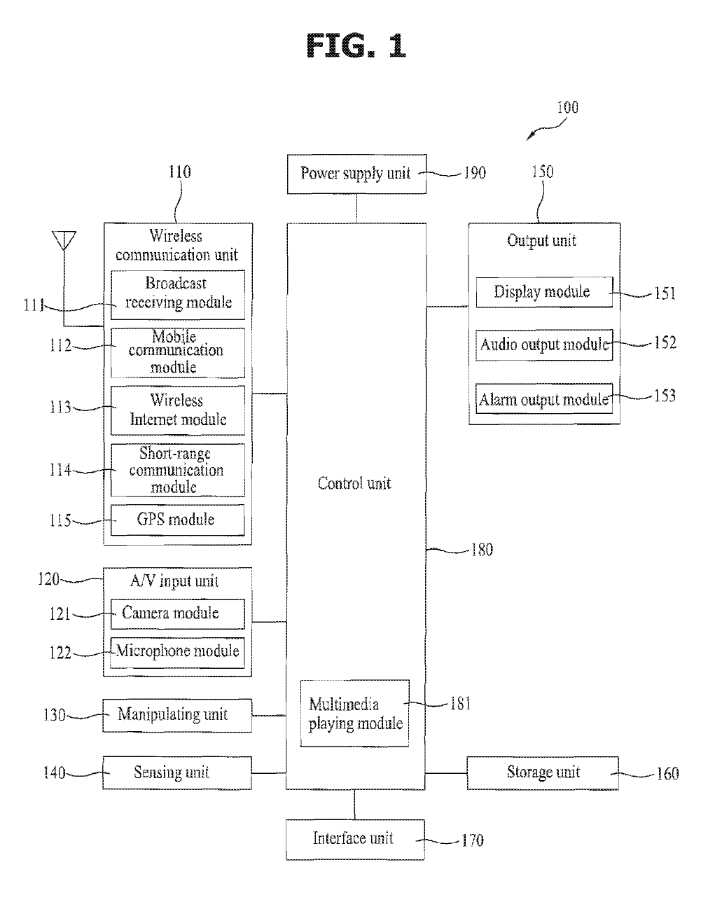

FIG. 1 is a block diagram of a mobile terminal in accordance with one embodiment of the present invention.

The mobile terminal 100 may comprise components, such as a wireless communication unit 110, an Audio/Video (NV) input unit 120, a user input unit 130, a sensing unit 140, an output unit 150, a memory 160, an interface unit 170, a controller 180, a power supply 190 and the like. FIG. 1 shows the mobile terminal 100 having various components, but it is understood that implementing all of the illustrated components is not a requirement. Greater or fewer components may alternatively be implemented.

Hereinafter, each component is described in sequence.

The wireless communication unit 110 may typically include one or more components which permit wireless communications between the mobile terminal 100 and a wireless communication system or between the mobile terminal 100 and a network within which the mobile terminal 100 is located. For example, the wireless communication unit 110 may include a broadcast receiving module 111, a mobile communication module 112, a wireless internet module 113, a short-range communication module 114, a position location module 115 and the like.

The broadcast receiving module 111 receives a broadcast signal and/or broadcast associated information from an external broadcast managing entity via a broadcast channel. The broadcast channel may include a satellite channel and a terrestrial channel. The broadcast managing entity may indicate a server which generates and transmits a broadcast signal and/or broadcast associated information or a server which receives a pre-generated broadcast signal and/or broadcast associated information and sends them to the mobile terminal. Examples of broadcast associated information may include information associated with a broadcast channel, a broadcast program, a broadcast service provider, and the like. The broadcast signal may be implemented as a TV broadcast signal, a radio broadcast signal, and a data broadcast signal, among others. The broadcast signal may further include a data broadcast signal combined with a TV or radio broadcast signal.

The broadcast associated information may be provided via a mobile communication network, and received by the mobile communication module 112.

The broadcast associated information may be implemented in various formats. For instance, broadcast associated information may include Electronic Program Guide (EPG) of Digital Multimedia Broadcasting (DMB), Electronic Service Guide (ESG) of Digital Video Broadcast-Handheld (DVB-H), and the like.

The broadcast receiving module 111 may be configured to receive digital broadcast signals transmitted from various types of broadcast systems. Such broadcast systems may include Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Integrated Services Digital Broadcast-Terrestrial (ISDB-T), and the like. The broadcast receiving module 111 may be configured to be suitable for every broadcast system transmitting broadcast signals as well as the digital broadcasting systems.

Broadcast signals and/or broadcast associated information received via the broadcast receiving module 111 may be stored in a suitable device, such as a memory 160.

The mobile communication module 112 transmits/receives wireless signals to/from at least one of network entities (e.g., base station, an external mobile terminal, a server, etc.) on a mobile communication network. Here, the wireless signals may include audio call signal, video call signal, or various formats of data according to transmission/reception of text/multimedia messages.

The wireless internet module 113 supports wireless Internet access for the mobile terminal. This module may be internally or externally coupled to the mobile terminal. Examples of such wireless Internet access may include Wireless LAN (WLAN) (Wi-Fi), Wireless Broadband (Wibro), World Interoperability for Microwave Access (Wimax), High Speed Downlink Packet Access (HSDPA), and the like.

The short-range communication module 114 denotes a module for short-range communications. Suitable technologies for implementing this module may include BLUETOOTH, Radio Frequency IDentification (RFID), Infrared Data Association (IrDA), Ultra-WideBand (UWB), ZigBee, and the like.

The position location module 115 denotes a module for detecting or calculating a position of a mobile terminal. An example of the position location module 115 may include a Global Position System (GPS) module. Under the current technique, the GPS module can measure accurate time and distance respectively from more than three satellites so as to accurately calculate a current position of the mobile terminal based on such three different distances according to a triangulation scheme. A scheme may be used to obtain time information and distance information from three satellites and correct error by one satellite. Also, the GPS module may continuously calculate a current position in real time so as to obtain speed information.

The A/V input unit 120 is configured to provide audio or video signal input to the mobile terminal. The A/V input unit 120 may include a camera 121 and a microphone 122. The camera 121 receives and processes image frames of still pictures or video obtained by image sensors in a video call mode or a capturing mode. The processed image frames may be displayed on a display 151.

The image frames processed by the camera 121 may be stored in the memory 160 or transmitted to the exterior via the wireless communication unit 110. Two or more cameras 121 may be provided according to the configuration of the mobile terminal.

The microphone 122 may receive an external audio signal via a microphone while the mobile terminal is in a particular mode, such as a phone call mode, a recording mode, a voice recognition mode, or the like. This audio signal is processed into digital data. The processed digital data is converted for output into a format transmittable to a mobile communication base station via the mobile communication module 112 in case of the phone call mode. The microphone 122 may include assorted noise removing algorithms to remove noise generated in the course of receiving the external audio signal.

The user input unit 130 may generate input data inputted by a user to control the operation of the mobile terminal. The user input unit 130 may include a keypad, a dome switch, a touchpad (e.g., static pressure/capacitance), a jog wheel, a jog switch and the like. A specific example can be one in which the touchpad is layered with the display 151 to be explained later so as to be in cooperation with the display 151, which is referred to as a touch screen.

The sensing unit 140 provides status measurements of various aspects of the mobile terminal. For instance, the sensing unit 140 may detect an open/close status of the mobile terminal, a change in a location of the mobile terminal 100, a presence or absence of user contact with the mobile terminal 100, the location of the mobile terminal 100, acceleration/deceleration of the mobile terminal 100, and the like, so as to generate a sensing signal for controlling the operation of the mobile terminal 100. For example, regarding a slide-type mobile terminal, the sensing unit 140 may sense whether a sliding portion of the mobile terminal is open or closed. Other examples include sensing functions, such as the sensing unit 140 sensing the presence or absence of power provided by the power supply 190, the presence or absence of a coupling or other connection between the interface unit 170 and an external device, and the like. Here, the sensing unit 140 may include a proximity sensor 141, which will be described later in relation to a touch screen.

The interface unit 170 is generally implemented to couple the mobile terminal to external devices. The interface unit 170 may include, for example, wired/wireless headset ports, external charger ports, wired/wireless data ports, memory card ports, ports for coupling devices having an identification module, etc.), audio Input/Output (I/O) ports, video I/O ports, earphone ports, and the like.

The identification module may be configured as a chip for storing various information required to authenticate an authority to use the mobile terminal 100, which may include a User Identity Module (UIM), a Subscriber Identity Module (SIM), a Universal Subscriber Identity Module (USIM), and the like. Also, the device having the identification module (hereinafter, referred to as ‘identification device’) may be implemented in a type of smart card. Hence, the identification device can be coupled to the mobile terminal 100 via a port. Such interface unit 170 may receive data from an external device, or provided with power and accordingly transfer the received data or power to each component within the mobile terminal 100 or transfer data of the mobile terminal 100 to an external device.

Also, the interface unit 170 may serve as a path for power to be supplied from an external cradle to the mobile terminal 100 when the mobile terminal 100 is connected to the external cradle or as a path for transferring various command signals inputted from the cradle by a user to the mobile terminal 100. Such various command signals or power inputted from the cradle may operate as signals for recognizing that the mobile terminal 100 has accurately been mounted to the cradle.

The output unit 150 is configured to output an audio signal, a video signal or an alarm signal. The output unit 150 may include a display 151, an audio output module 152, an alarm 153, and the like.

The display 151 may output information processed in the mobile terminal 100. For example, when the mobile terminal is operating in a phone call mode, the display 151 will provide a User Interface (UI) or a Graphic User Interface (GUI) which includes information associated with the call. As another example, if the mobile terminal is in a video call mode or a capturing mode, the display 151 may additionally or alternatively display images captured and/or received, UI, or GUI.

Meanwhile, as mentioned above, a touch screen can be configured as the display 151 and the touchpad are layered with each other to work in cooperation with each other. This configuration permits the display 151 to function both as an input device and an output device. The display 151 may be implemented using, for example, a Liquid Crystal Display (LCD), a Thin Film Transistor-Liquid Crystal Display (TFT-LCD), an Organic Light-Emitting Diode (OLED), a flexible display, a three-dimensional (3D) display, or the like. Some of the displays can be configured to be transparent such that it is possible to see the exterior therethrough. These displays may be called transparent displays. A representative example of the transparent display may include a Transparent Organic Light Emitting Diode (TOLED), and the like. The mobile terminal 100 may include two or more of such displays 151 according to its embodiment. For example, the mobile terminal 100 may simultaneously include an external display (not shown) and an internal display (not shown). The touch screen may be configured so as to detect a touch input pressure as well as touch input position and touch input area.

The audio output module 152 may output audio data which is received from the wireless communication unit 110 in various modes including call-receiving mode, call-placing mode, recording mode, voice recognition mode, broadcast reception mode, and the like, or audio data stored in the memory 160. Also, the audio output module 152 may output an audio signal relating to a particular function (e.g., call received, message received, etc.) performed in the mobile terminal 100. The audio output module 152 may be implemented using a speaker, a buzzer, or the like.

The alarm 153 may output a signal to inform a generation of event associated with the mobile terminal 100. Typical events may include call received, message received, user input received and the like. In addition to generating the audio or video signal, the alarm 153 may also inform the event generation in different manners, for example, by providing tactile sensations (e.g., vibration) to a user. The alarm 153 may also be configured to vibrate responsive to the mobile terminal receiving a call or message. As another example, vibration is provided by the alarm 153 responsive to receiving user input at the mobile terminal, thus providing a tactile feedback mechanism. Such vibration can also be provided to make a user recognize the event generation. The signal informing the event generation may be outputted via the display 151 or the audio output module 152.

The memory 160 may store a program for the processing and control of the controller 180. Alternatively, the memory 160 may temporarily store input/output data (e.g., phonebook data, messages, still images, video and the like). Also, the memory 160 may store data related to various patterns of vibrations and audio outputted upon the touch input on the touch screen.

The memory 160 may be implemented using any type of suitable storage medium including a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, optical disk, and the like. Also, the mobile terminal 100 may operate a web storage which performs the storage function of the memory 160 on the Internet.

The controller 180 typically controls the overall operations of the mobile terminal. For example, the controller 180 performs the control and processing associated with voice calls, data communications, video calls, and the like. The controller 180 may include a multimedia module 181 which provides multimedia playback. The multimedia module 181 may be configured as part of the controller 180 or as a separate component.

The controller 180 can perform a pattern recognition processing so as to recognize writing or drawing input on the touch screen as text or image.

The power supply 190 provides power required by various components under the control of the controller 180. The provided power may be internal power, external power, or combination thereof.

Various embodiments described herein may be implemented in a computer-readable medium using, for example, software, hardware, or some combination thereof.

For a hardware implementation, the embodiments described herein may be implemented within one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller 180.

For software implementation, the embodiments such as procedures and functions may be implemented together with separate software modules each of which performs at least one of functions and operations. The software codes can be implemented with a software application written in any suitable programming language. Also, the software codes may be stored in the memory 160 and executed by the controller 180.

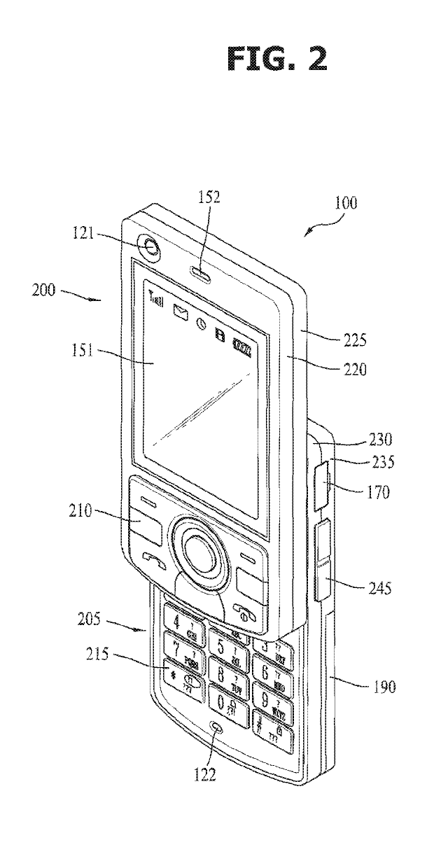

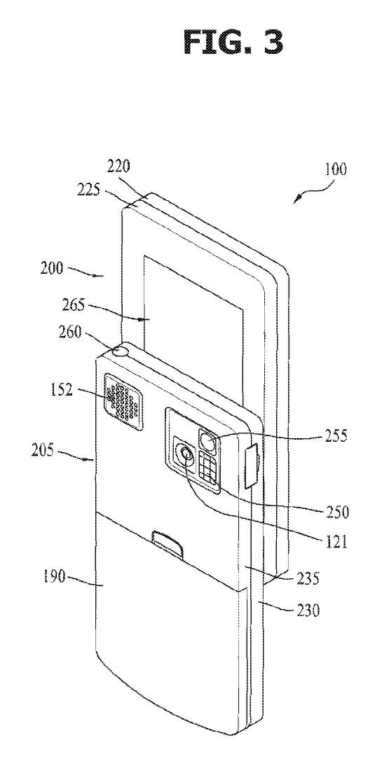

As mentioned above, the internal components of the mobile terminal related to the present invention have been described from the perspective of their functions. Hereinafter, external components of the mobile terminal related to the present invention will be described from the perspective of their functions with reference to FIGS. 2 and 3. The mobile terminal may be implemented in a variety of different configurations. Examples of such configurations include folder type, slide type, bar type, rotating type, swing type or the like. For the sake of brief explanation, further disclosure will primarily relate to a slide-type mobile terminal. However, the present invention may not be limited to the slide-type mobile terminal, but can be applied to other types of terminals including the aforesaid types of terminals.

FIG. 2 is a front perspective view of a mobile terminal in accordance with one embodiment of the present invention.

The mobile terminal 100 of the present invention may comprise a first body 200, and a second body 205 configured to slidably cooperate with the first body 200 in at least one direction. For a folder-type mobile terminal, the mobile terminal 100 may include a first body, and a second body configured to have at least one side folded or unfolded with respect to the first body 200.

The first body 200 is positioned over the second body 205 in a manner that the second body 205 is obscured by the first body 200. This state can be referred to as a closed configuration (position). As illustrated in FIG. 2, the state where the first body 200 exposes at least part of the second body 205 can be referred to as an open configuration (position).

In the meantime, the mobile terminal according to the present invention, although not shown in the drawing, may be a folder-type mobile terminal including a first body and a second body having one side folded or unfolded with respect to the first body. Here, the folded state of the second body can be referred to as the closed configuration, whereas the unfolded state of the second body can be referred to as the open configuration.

In addition, the mobile terminal according to the present invention, although not shown in the drawing, may be a swing-type mobile terminal including a first body and a second body capable of being swung with respect to the first body. Here, the state that the first body is overlapped with the second body can be referred to as the closed configuration whereas the state that the second body is swung thus to make the first body partially exposed can be referred to as the open configuration.

Even if any separate description is not given of the folder-type mobile terminal and the swing-type mobile terminal, it can be easily understood by those skilled in the art and thus a detailed description thereof will not be repeated.

The mobile terminal 100 may be operable in a standby (idle) mode when in the closed configuration, but this mode can be released by the user's manipulation. Also, the mobile terminal 100 may typically be operable in an active (phone call) mode in the open configuration. Here, this mode may be changed into the idle mode according to the user's manipulation or after a certain time elapses.

A case (housing, casing, cover, etc.) forming the outside of the first body 200 is formed by a first front case 220 and a first rear case 225. Various electronic components may be disposed in a space between the first front case 220 and the first rear case 225. One or more intermediate cases may additionally be disposed between the first front case 220 and the first rear case 225.

The cases can be formed of resin in a manner of injection molding, or formed using metallic materials such as stainless steel (STS) and titanium (Ti).

A display 151, an audio output module 152, a camera 121 or a first user input unit 210 may be disposed at the first front case 220 of the first body 200.

The display 151 has been described in connection with FIG. 1, so its detailed description will not be repeated for the sake of brief explanation.

The audio output module 152 may be implemented as a speaker.

The camera 121 may be implemented to be suitable for a user to capture still images or video.

Like the first body 200, a case configuring the outside of the second body 205 may be formed by a second front case 230 and a second rear case 235.

The second user input unit 215 may be disposed at the second body 205, in detail, at a front face of the second front case 230.

A third user input unit 245, a microphone 122 and an interface unit 170 may be disposed either at the second front case 230 or at the second rear case 235.

The first to third user input units 210, 215 and 245 may be named as a user input unit 130. Any tactile manner that a user can touch, e.g., the display 151, for manipulation can be employed for the user input unit 130.

For example, the user input unit 130 can be implemented as a dome switch or touchpad which a user can input information in a pushing or touching manner, or implemented in a manner of using a wheel, a jog or a joystick to rotate keys.

Regarding each function, the first user input unit 210 is used for inputting commands such as START, END, SCROLL or the like, and the second user input unit 215 is used for inputting numbers, characters, symbols, or the like. The first user input unit 210 may include so-called soft keys used in cooperation with icons displayed on the display 151, and navigation keys (usually composed of four navigation keys and a center key) for indicating and confirming an orientation.

Also, the third user input unit 245 can be operated as a hot key for activating a specific function within the mobile terminal.

The microphone 122 may be implemented to be suitable for receiving user's voice or various sounds.

The interface unit 170 may be used as a passage through which the terminal related to the present invention can exchange data or the like with an external device. The interface unit 170 has been described in connection with FIG. 1, so its detailed description will be omitted.

The power supply 190 may be disposed at a side of the second rear case 235 to provide power to the mobile terminal.

The power supply 190 may be a rechargeable battery, for example, to be attachable/detachable for charging.

FIG. 3 is a rear perspective view of the mobile terminal of FIG. 2.

As shown in FIG. 3, a camera 121 may further be disposed at a rear face of the second rear case 235 of the second body 205. The camera 121 of the second body 205 faces a direction which is opposite to a direction faced by the camera 121 of the first body 200, and may have different pixels from those of the camera 121 of the first body 200.

For example, the camera 121 of the first body 200 may operate with relatively lower pixels (lower resolution). Thus, the camera 121 of the first body 200 may be useful when a user can capture his face and send it to another party during a video call or the like. On the other hand, the camera 121 of the second body 205 may operate with a relatively higher pixels (higher resolution) such that it can be useful for a user to obtain higher quality pictures for later use.

A flash 250 and a mirror 255 may additionally be disposed adjacent to the camera 121 of the second body 205. The flash 250 operates in conjunction with the camera 121 of the second body 250 when taking a picture using the camera 121 of the second body 205. The mirror 255 can cooperate with the camera 121 of the second body 205 to allow a user to photograph himself in a self-portrait mode.

The second rear case 235 may further include an audio output module 152.

The audio output module 152 of the second body 205 can cooperate with the audio output module 152 of the first body 200 to provide stereo output. Also, the audio output module 152 may be configured to operate as a speakerphone.

A broadcast signal receiving antenna 260 may be disposed at one side of the second rear case 235, in addition to an antenna for communications. The antenna 260 can be configured to retract into the second body 205.

One part of a slide module 265 which allows the first body 200 to be slidably coupled to the second body 205 may be disposed at the first rear case 225 of the first body 200.

The other part of the slide module 265 may be disposed at the second front case 230 of the second body 205, such that it may not be exposed to the exterior as illustrated in the drawing of the present invention.

As such, it has been described that the camera 121 is disposed at the second body 205; however, the present invention may not be limited to the configuration.

For example, it is also possible that one or more of those components (e.g., 260, 121˜250, 152, etc.), which have been described to be implemented on the second rear case 235, such as the camera 121, will be implemented on the first body 200, particularly, on the first rear case 225. In this configuration, the component(s) disposed on the first rear case 225 can be protected by the second body 205 in a closed position of the mobile terminal. In addition, without the camera 121 of the second body 205, the camera 121 of the first body 200 can be implemented to be rotatable so as to rotate up to a direction which the camera 121 of the second body 205 faces.

The mobile terminal 100 of FIGS. 1 to 3 may be configured to operate within a communication system which transmits data via frames or packets, including both wireless and wireline communication systems, and satellite-based communication systems.

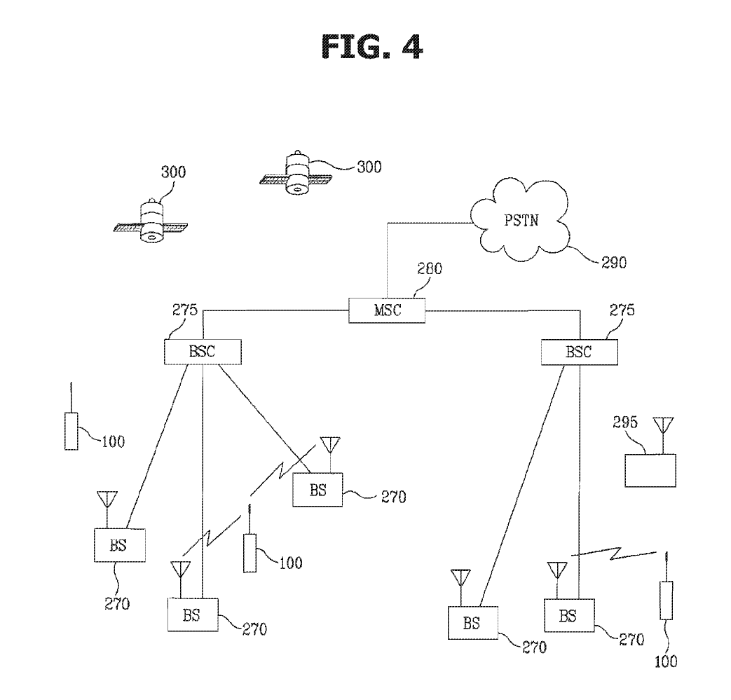

Hereinafter, a communication system within which the mobile terminal related to the present invention can operate will be described with reference to FIG. 4.

Such communication systems utilize different air interfaces and/or physical layers. Examples of such air interfaces utilized by the communication systems include Frequency Division Multiple Access (FDMA), Time Division Multiple Access (TDMA), Code Division Multiple Access (CDMA), and Universal Mobile Telecommunications System (UMTS), the Long Term Evolution (LTE) of the UMTS, the Global System for Mobile Communications (GSM), and the like. By way of non-limiting example only, further description will relate to a CDMA communication system, but such teachings apply equally to other system types including the CDMA wireless communication system.

Referring now to FIG. 4, a CDMA wireless communication system is shown having a plurality of mobile terminals 100, a plurality of base stations (BSs) 270, base station controllers (BSCs) 275, and a mobile switching center (MSC) 280. The MSC 280 is configured to interface with a conventional Public Switch Telephone Network (PSTN) 290. The MSC 280 is also configured to interface with the BSCs 275. The BSCs 275 are coupled to the base stations 270 via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs 275 can be included in the system as shown in FIG. 4.

Each base station 270 may include one or more sectors, each sector having an omni-directional antenna or an antenna pointed in a particular direction radially away from the base station 270. Alternatively, each sector may include two or more different antennas. Each base station 270 may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations 270 may also be referred to as Base Station Transceiver Subsystems (BTSs). In some cases, the term “base station” may be used to refer collectively to a BSC 275, and one or more base stations 270. The base stations may also be denoted as “cell sites.” Alternatively, individual sectors of a given base station 270 may be referred to as cell sites.

A broadcasting transmitter (BT) 295, as shown in FIG. 4, transmits a broadcast signal to the mobile terminals 100 operating within the system. The broadcast receiving module 111 (FIG. 1) is typically configured inside the mobile terminal 100 to receive broadcast signals transmitted by the BT 295.

FIG. 4 further depicts several Global Positioning System (GPS) satellites 300. Such satellites 300 facilitate locating the position of at least one of plural mobile terminals 100. Two satellites are depicted in FIG. 4, but it is understood that useful position information may be obtained with greater or fewer satellites than two satellites. The GPS module 115 (FIG. 1) is typically configured to cooperate with the satellites 300 to obtain desired position information. It is to be appreciated that other types of position detection technology, (i.e., location technology that may be used in addition to or instead of GPS location technology) may alternatively be implemented. If desired, at least one of the GPS satellites 300 may alternatively or additionally be configured to provide satellite DMB transmissions.

During typical operation of the wireless communication system, the base stations 270 receive sets of reverse-link signals from various mobile terminals 100. The mobile terminals 100 are engaging in calls, messaging, and executing other communications. Each reverse-link signal received by a given base station 270 is processed within that base station 270. The resulting data is forwarded to an associated BSC 275. The BSC 275 provides call resource allocation and mobility management functionality including the orchestration of soft handoffs between base stations 270. The BSCs 275 also route the received data to the MSC 280, which then provides additional routing services for interfacing with the PSTN 290. Similarly, the PSTN 290 interfaces with the MSC 280, and the MSC 280 interfaces with the BSCs 275, which in turn control the base stations 270 to transmit sets of forward-link signals to the mobile terminals 100.

In general, in order to receive presence information, designated contacts may be selected or subscription for a contacts list (or group) may be performed. The subscription may denote an operation by which the controller 180 requests user's presence information from a presence server.

That is, at a subscription time, the controller 180 performs the subscription for requesting presence information relating to the same presence contacts from the presence server. Hence, every subscription time, the controller 180 should receive presence information relating to the designated contacts from the presence server and display and update the presence information. Accordingly, a frequent presence processing increases a battery (current) consumption. Furthermore, a lot of presence information should be received and displayed, thereby further increasing presence maintenance costs and lowering a UI performance of a terminal.

The present invention accordingly proposes an approach in which presence information merely relating to necessary contacts are received and displayed by presetting a reception range of the presence information, so as to reduce the presence maintenance costs and improve the UI performance of the terminal.

To this end, the present invention sets a reception range of presence information based upon contacts with which a user frequently communicates when receiving presence information and displaying the same on a screen.

Preferably, the reception range of the presence information may be set for each group by virtue of a preset menu. the number of subscription and subscription duration (time, period) for contacts within each group may be set depending on a frequency of communication, priority, an on/offline state, positions and the like. The frequency of communication may include every type of communication mechanism for exchanging voice messages, text messages, instant messaging (IM) and the like. That is, within the reception range of the presence information, it may be set up to how many contacts subscription is to be performed or up to how many contacts engaged in a call within several recent days subscription is to be performed.

While displaying contacts on a screen according to the reception range of the presence information, the late contacts engaged in a call are displayed on an upper portion of the screen together with the presence information and sequentially the normal contacts are displayed. Especially, the displaying may be configured by discriminating contacts with a high frequency of communication from contacts with a low frequency of communication.

Also, in accordance with the present invention, if a reception range of the presence information is set for preset contacts, subscription may be performed only for contacts belonging to a group which is open on the current UI screen (available for communication), namely, transmission of presence information is requested from a presence server. In other words, presence information for contacts within a communication-unavailable group is not received.

The present invention may also be implemented such that groups not engaged in a call communication may be distinguishable from a group engaged in a call.

Hereinafter, a method of displaying presence information in a mobile terminal will be described in more detail.

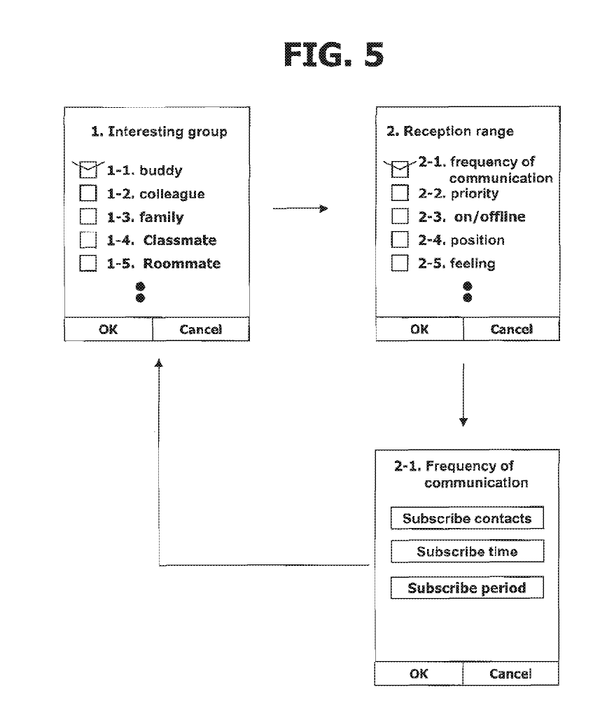

FIG. 5 is an exemplary view for setting a reception range of presence information in a mobile terminal in accordance with one embodiment of the present invention.

As shown in FIG. 5, if a user selects one interesting group, for example, ‘buddy’ group from a user menu, the controller 180 controls the display unit 15 to display a reception range setup menu on a screen for allowing a user to set the reception range (subscription range) for the selected buddy group. The reception range setup menu may include a frequency of communication, priority, an on/offline state, a position and the like. Besides, the reception range setup menu may include every element by which parties having engaged in a call can be identified.

If the user selects the item “frequency of communication” from the reception range setup menu, then the controller 180 controls the display unit 15 to output detailed items for setting contacts to which subscription is to be performed, a communication duration and a subscription duration. Among the detailed items, the user may set up to how many contacts he or she is to subscribe to or up to how many contacts having communicated (call connected) within several recent days he or she is to subscribe to, and the subscription duration.

Especially, FIG. 5 illustrates a method of setting the reception range of the presence information on one screen in a tree structure. According to the method, once the reception range of the presence information is set for one group, the same operation is repeated to set a reception range of presence information for other groups.

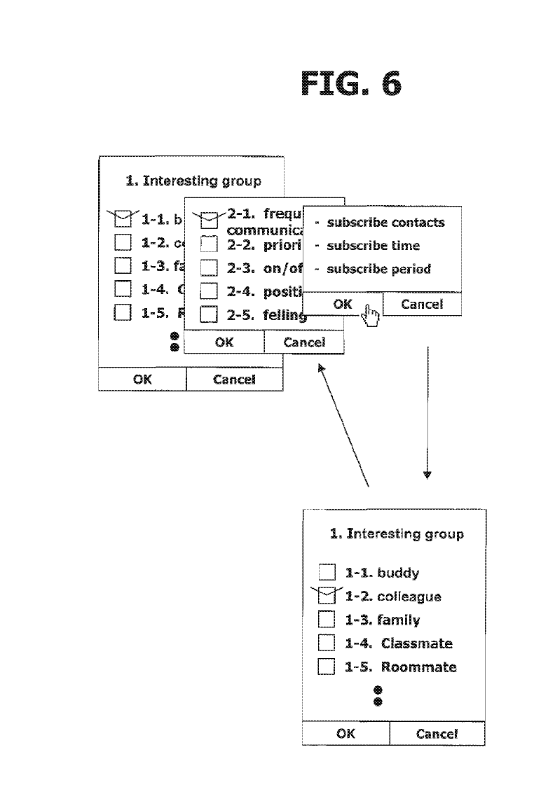

FIG. 6 is another exemplary view for setting the reception range of presence information in accordance with the present invention, which sets a reception range of presence information using a separate output window. In accordance with the embodiment shown in FIG. 6, if an interesting group and detailed reception condition setup items are all set, the terminal may automatically return to its initial menu state for specifying the interesting group.

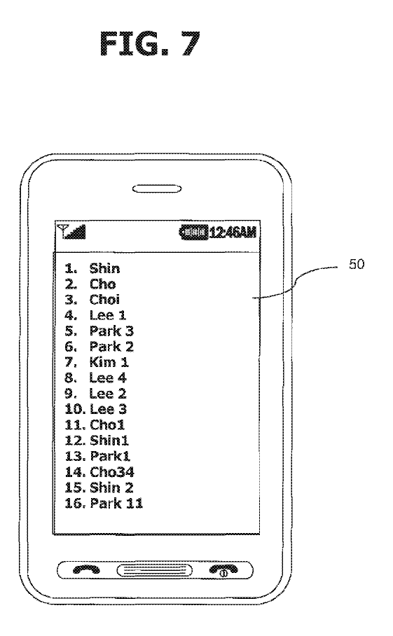

First, it is assumed within the reception range of the presence information that the interesting group is set to a buddy group, a reception condition is set to the order of the frequency of communication, and the number of contacts is fixed to 8, and a subscription is performed for contacts having engaged in a call within three days. FIG. 7 exemplarily illustrates a recent call list.

In this case, the controller 180 sets the reception range (i.e., subscription range) such that the subscription is to be performed for buddies (contacts) up to the 8^{th} buddy within the interesting group in the order of the frequency of communication based upon the call list of FIG. 7. That is, the controller 180 requests presence information for the buddies (contacts) up to the 8^{th} buddy from the presence server and displays the received information. Afterwards, at the subscription duration of time, the controller 180 re-subscribes to buddies up to the 8^{th} buddy within the recent call list.

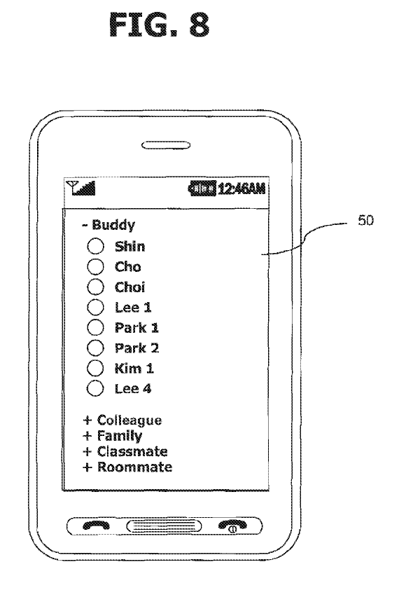

FIG. 8 is a screen displayed in case where a reception range of presence information has been set in accordance with an embodiment of the present invention.

As shown in FIG. 8, a group open on a screen 50, namely, currently engaged in a call is “buddy.” The controller 180 then requests presence information from the presence server for contacts belonging to the preset subscription range in the buddy group, and does not request presence information for other groups (e.g., colleague, family, classmate and roommate), which are not engaged in a call, namely, not open on the screen, so as to reduce maintenance costs and improve a UI performance.

Here, the controller 180 represents a separate mark (e.g., “+”) for the groups (e.g., colleague, family, classmate and roommate), which are not engaged in a call, thereby discriminating those groups from the buddy group engaged in a call.

Therefore, the controller 180 may not receive the presence information relating to the non-interesting buddies (i.e., buddies out of the subscription range) from the presence server. Especially, the controller 180 may display buddies such as Kim 1 and Park 4 to be distinguishable from other buddies because they have relatively lower frequency of communication.

Afterwards, at the subscription time, the controller 180 re-performs the subscription for the contacts up to the 8^{th} buddy. Consequently, the subscription can be performed for the contacts (buddies) belonging to the subscription range among a plurality of buddies while not performed for the contacts who are not in interest or infrequently engaged in a call. Therefore, a current consumption caused in the related art due to processing of presence information for a plurality of users can be reduced.

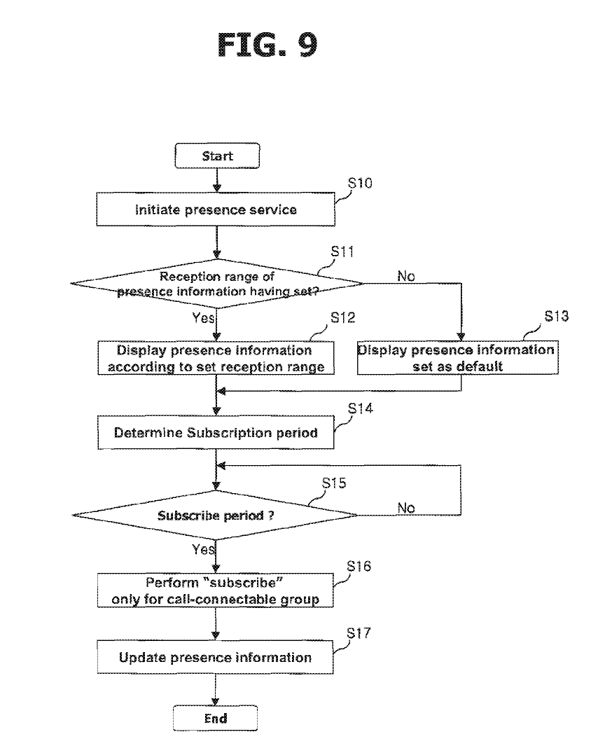

FIG. 9 is a flowchart illustrating a presence information management method for a mobile terminal in accordance with an embodiment of the present invention.

The controller 180, as shown in FIGS. 5 and 6, receives a reception range of presence information input by a user and stores the same in the memory 160.

Afterwards, if the user initiates a presence service such as an instant messaging (IM) service (S10), then the controller 180 checks whether the reception range (subscription range) of presence information has been set (S11).

If it is checked that the reception range of the presence information has been set, the controller 180, as shown in FIG. 8, displays a specific group and contacts to be subscribed to, which are included in the group, according to the preset reception range (S12).

On the other hand, if it is checked that the reception range of the presence information has not been set, the controller 180 displays all of the contacts on a screen, as similar to the related art (S13).

Afterwards, at a subscription time set in the reception range (S14, S15), then the controller 180, as shown in FIG. 8, requests presence information relating to contacts to be subscribed, namely, the buddies, who are displayed on the current screen 50, from the presence server, and then updates the presence information relating to the corresponding contacts to be subscribed to by use of the presence information received from the presence server (S16, S17).

On the other hand, if it is checked that the reception range of the presence information has not been set, the controller 180 requests presence information relating to all of the contacts from the presence server and displays the corresponding information on the screen 50.

As mentioned above, according to the present invention, when receiving a presence service, a reception range of presence information can be preset such that presence information of users who are not in interest or infrequently engaged in a call are not needed to be processed, thereby reducing a current consumption due to the presence information processing and improving a user interface (UI) performance. In particular, the present invention can define the subscription/presence range so as to allow presence information to be more conveniently managed upon executing a usage based charge.

In addition, the present invention may request less presence information from the presence server for reception, thereby lowering maintenance costs of the presence service. Also, the present invention employs a UI for representing users depending on a frequency of communication, thereby facilitating recognition of users who frequently talk on the phone.

Further, in accordance with one embodiment of the present invention, the method can be implemented as computer-readable codes in a program-recorded medium. The computer-readable medium may include all types of recording devices each storing data readable by a computer system. Examples of such computer-readable media may include ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the mobile terminal.

The configurations and methods of the mobile terminal in the aforesaid embodiments may not be limitedly applied, but such embodiments may be configured by a selective combination of all or part of the embodiments so as to implement many variations.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A presence information management method for a mobile terminal comprising:
setting a reception range of presence information;
storing the set reception range of the presence information;
displaying on a screen contacts included in the reception range of the presence information upon an initiation of a presence service; and
requesting presence information relating to the displayed contacts from a presence server.

2. The method of claim 1, wherein the reception range of the presence information is set via a separate setup menu.

3. The method of claim 1, wherein the reception range of the presence information is set for each group.

4. The method of claim 1, wherein the reception range of the presence information is set for each group depending on a frequency of communication, priority, an on/offline state and a position.

5. The method of claim 4, wherein the reception range of the presence information comprises, for each group, contacts for which presence information is to be requested, and a time section and a duration of time for which presence information is to be requested from a server.

6. The method of claim 1, wherein the presence information is periodically requested according to the duration of time included in the reception range.

7. The method of claim 1, further comprising updating presence information relating to the corresponding contacts using the presence information received from the presence server.

8. The method of claim 1, wherein upon the initiation of the presence service, a group included in the reception range of the presence information is distinguishably displayed from non-included groups, the group included in the reception range of the presence information being displayed together with contacts belonging thereto.

9. The method of claim 1, wherein contacts having a relatively low frequency of communication, among the contacts included in the reception range, are displayed to be distinguishable from the other contacts.

10. A mobile terminal comprising:
a memory configured to store a reception range of presence information;
a display configured to display the presence information; and
a controller configured to receive presence information belonging to a reception range of presence information stored in a memory, upon an initiation of a presence service, and display the received presence information on the display.

11. The terminal of claim 10, wherein the reception range of the presence information is set for each group via a separate setup menu.

12. The terminal of claim 10, wherein the reception range of the presence information is set for each group depending on a frequency of communication, priority, an on/offline state and a position.

13. The terminal of claim 10, wherein the reception range of the presence information comprises, for each group, contacts for which presence information is to be requested, and a time section and a duration of time for which presence information is to be requested from a server.

14. The terminal of claim 10, wherein the controller is configured to periodically request presence information only for contacts displayed on the screen according to duration of time included in the reception range.

15. The terminal of claim 10, wherein the controller is configured to update presence information of corresponding contacts using the presence information received from the presence server.

16. The terminal of claim 10, wherein the controller is configured to display a group included in the reception range of the presence information to be distinguishable from non-included groups upon an initiation of a presence service, the group included in the reception range of the presence information being displayed together with contacts belonging thereto.

17. The terminal of claim 10, wherein the controller is configured to display contacts having a relatively low frequency of communication, among all the contacts included in the reception range, to be distinguishable from the other contacts.
